(19) United States
(12) Patent Application Publication
(10) Pub. No.: US 2005/0138071 A1
(43) Pub. Date: Jun. 23, 2005

(54) Accurate time information for the operation of an automated data storage library

(75) Inventors: Brian Gerard Goodman, Tucson, AZ (US); Arthur John Colvig, Tucson, AR (US)

Correspondence Address: Allen K. Bates;IBM Corporation, Intellectual Property Law, 9000 South Rita Road, Tucson, AZ, 85744, US

(73) Assignee: International Business Machines Corporation

(21) Appl. No.: 10/741,723

(22) Filed: Dec. 18, 2003

(51) Int. Cl. G06F 17/00

(52) U.S. Cl. 707/104.1

(57) ABSTRACT

Disclosed are a system, a method, and article of manufacture to provide for obtaining time information in an automated data storage library. A receiver coupled to the library controller provides time information to the library controller for library operation. In another exemplary embodiment the automated data storage library further comprises an external interface for interfacing to at least one external system to provide time information to at least one external system.

### CROSS-REFERENCES TO RELATED APPLICATIONS

The present application is related to application Ser. No. ______, entitled “Global Positioning System Location Information for an Automated Data Storage Library” Docket # TUC9-2003-0088 filed on an even date herewith, the disclosure of which is hereby incorporated by reference in its entirety.

### TECHNICAL FIELD

The present invention relates to library systems for dynamic information storage or retrieval. More particularly, the invention concerns a system to provide accurate time information for the operation of an automated data storage library.

### BACKGROUND OF THE INVENTION

Automated data storage libraries provide a means for storing large quantities of data in data storage media that are not permanently mounted on data storage drives, and that are stored in a readily available form on storage shelves. One or more robot accessors retrieve selected data storage media from storage shelves and provide them to data storage drives. Typically, data stored on data storage media of an automated data storage library, once requested, is needed quickly.

Automated data storage libraries typically include Real-Time Clocks (RTC) to provide a time/date source for library operations. A real-time clock is a clock that maintains time and/or date information continuously despite changes in power supplied to the library. Real-time clocks are typically powered by a special battery that is not connected to the library power supply. In contrast, non-real time clocks do not function when power is removed from the library. The RTC may be used to schedule periodic drive cleaning, to schedule periodic maintenance operations such as accessor rezero or library calibration, for creating log time stamps, etc. A problem with prior art Real-Time clocks is the requirement of a power source to provide power to the RTC when the library is powered off. Capacitors may be used as a power source for the RTC; however, a very large capacitor may be required to store sufficient energy to maintain RTC operation for an extended period of time. Batteries are commonly used for RTC power; however, hazardous chemicals are often used in modern batteries resulting in potential disposal problems; also a battery failure may result in a service action. Another problem with prior art real-time clocks is the need to manually set the date and time by an operator or repair person. The time may not be set correctly or never set when required. Therefore, there is need to improve the supply of accurate time information in an automated data storage library.

Generally a Global Positioning System (GPS) provides an accurate time source with four atomic clocks in each GPS satellite. It also provides accurate ranging information. The ranging information can be used for relative and absolute positioning measurements, as well as attitude (roll, pitch and yaw) measurements. Sub-millimeter accuracy can be obtained with the GPS system.

In order to benefit from a very large wireless telephone market, GPS manufactures have been working on techniques to improve the indoor characteristics of GPS receivers. One approach that has shown remarkable success is a design that uses massively parallel correlators. This can improve the effective receiver sensitivity to about −158 dBm. Another approach uses a technique called A-GPS (Assisted GPS) which receives the GPS data stream from an additional source, such as a cellular telephone network. This improves indoor operation reduces the time to determining a position from seconds or minutes, to hundreds of milliseconds. In one product example, Motorola manufactures an OEM GPS sensor, called “FS Oncore” with an approximate size of 200 square millimeters. This is a complete GPS solution that only requires an antenna and a serial interface to receive location and time information. Another Motorola product called “Instant GPS”, is a single chip GPS receiver that is manufactured by IBM. This device requires minimum additional circuitry and Motorola provides reference designs for easy integration into products. In addition to the electrical integration, this solution only requires an antenna and a serial interface to receive location and time information. This new generation of single chip GPS receivers results in the availability of a low power and compact GPS system. In another product example, Global Locate manufactures a two chip GPS solution that requires a relatively small amount of electrical integration to operate in a product.

An automated data storage library typically comprises one or more controllers to direct the operation of the library. The controller may take many different forms and may comprise an embedded system, a distributed control system, a personal computer, workstation, etc. FIG. 1 shows a typical library controller 100 with a processor 102, RAM (Random Access Memory) 103, nonvolatile memory 104, device specific circuits 101, and I/O interface 105. Alternatively, the RAM 103 and/or nonvolatile memory 104 may be contained in the processor 102 as could the device specific circuits 101 and I/O interface 105. The processor 102 may comprise an off the shelf microprocessor, custom processor, FPGA (Field Programmable Gate Array), ASIC (Application Specific Integrated Circuit), discrete logic, etc. The RAM (Random Access Memory) 103 is typically used to hold variable data, stack data, executable instructions, etc. The nonvolatile memory 104 may comprise any type of nonvolatile memory such as EEPROM (Electrically Erasable Programmable Read Only Memory), flash PROM (Programmable Read Only Memory), battery backup RAM, hard disk drive, etc. The nonvolatile memory 104 is typically used to hold the executable firmware and any nonvolatile data. The I/O interface 105 comprises a communication interface that allows the processor 102 to communicate with devices external to the controller. Examples of I/O interface 105 may comprise serial interfaces such as RS-232 or USB (Universal Serial Bus), SCSI (Small Computer Systems Interface), Fibre Channel, etc. In addition, I/O interface 105 may comprise a wireless interface such as RF or Infrared. The device specific circuits 101 provide additional hardware to enable the controller 100 to perform unique functions such as motor control of a cartridge gripper, etc. The device specific circuits 101 may comprise electronics that provide Pulse Width Modulation (PWM) control, Analog to Digital Conversion (ADC), Digital to Analog Conversion (DAC), etc. In addition, all or part of the device specific circuits 101 may reside outside the controller 100.

FIG. 2 illustrates an automated data storage library 10 with left hand service bay 13, one or more storage frames 11, and right hand service bay 14. As will be discussed, a frame may comprise an expansion component of the library. Frames may be added or removed to expand or reduce the size and/or functionality of the library. Frames may comprise storage shelves, drives, import/export stations, accessors, operator panels, etc. FIG. 3 shows an example of a storage frame 11, which also is the minimum configuration of the library 10 in FIG. 2. In this minimum configuration, there is no redundant accessor or service bay. The library is arranged for accessing data storage media (not shown) in response to commands from at least one external host system (not shown), and comprises a plurality of storage shelves 16, on front wall 17 and rear wall 19, for storing data storage cartridges that contain data storage media; at least one data storage drive 15 for reading and/or writing data with respect to the data storage media; and a first accessor 18 for transporting the data storage media between the plurality of storage shelves 16 and the data storage drive(s) 15. The storage frame 11 may optionally comprise an operator panel 23 or other user interface, such as a web-based interface, which allows a user to interact with the library. The storage frame 11 may optionally comprise an upper I/O station 24 and/or a lower I/O station 25, which allows data storage media to be inserted into the library and/or removed from the library without disrupting library operation. The library 10 may comprise one or more storage frames 11, each having storage shelves 16 accessible by first accessor 18. As described above, the storage frames 11 may be configured with different components depending upon the intended function. One configuration of storage frame 11 may comprise storage shelves 16, data storage drive(s) 15, and other optional components to store and retrieve data from the data storage cartridges. The first accessor 18 comprises a gripper assembly 20 for gripping one or more data storage media and may include a bar code scanner 22 or reading system, such as a smart card reader or similar system, mounted on the gripper 20, to “read” identifying information about the data storage media.

### SUMMARY OF THE INVENTION

Broadly defined, the present invention provides a system and a method for obtaining time information in an automated data storage library. In exemplary embodiments, the system includes a library controller for operating the automated data storage library and a receiver for receiving time information from various sources.

In system embodiments the present invention also provides a receiver coupled to the library controller, wherein the library controller obtains time information from the receiver and uses the time information for library operations. In another exemplary system embodiment the automated data storage library further comprises an external interface for interfacing to at least one external system to provide time information to at least one external system.

In method form, exemplary embodiments include a method for obtaining time information in an automated data storage library. The method comprises the steps of receiving a first signal using a first receiver; providing information derived from the first signal to a library controller; obtaining time information from the information; and the library controller using the time information for library operations.

In still another exemplary method of the present invention, a method for obtaining time information in an automated data storage library that further comprises an external interface for interfacing to at least one external system is presented. The method comprises the steps of receiving a first signal using a first receiver; providing information derived from the first signal to a library controller; obtaining time information from the information; using the time information for library operations; and the automated data storage library providing the time information to at least one external system via the external interface.

It will be appreciated by those skilled in the art that although the following detailed description will proceed with reference being made to preferred embodiments and methods of use, the present invention is not intended to be limited to these preferred embodiments and methods of use. Rather, the present invention is intended to be limited only as set forth in the accompanying claims.

For a more detailed understanding of the present invention, reference may be made to the following detailed description taken in conjunction with the accompanying drawings.

### BRIEF DESCRIPTION OF THE DRAWINGS

FIG. 1 is a block diagram of a library controller which may implement the method of the present invention.

FIG. 2 illustrates an automated data storage library comprising a left hand service bay, multiple storage frames and a right hand service bay.

FIG. 3 illustrates a configuration of the automated data storage library of FIG. 2.

FIG. 4 illustrates an embodiment of an automated data storage library which employs a distributed system of processor nodes.

FIG. 5 illustrates a front and rear view of a data storage drive mounted in a drive canister.

FIGS. 6A and 6B show block diagrams of systems to send and receive time information in an automated data storage library.

FIG. 7 is a flow chart showing steps to provide time information for an automated data storage library.

FIG. 8 is a flow chart showing steps to provide time information to an external system.

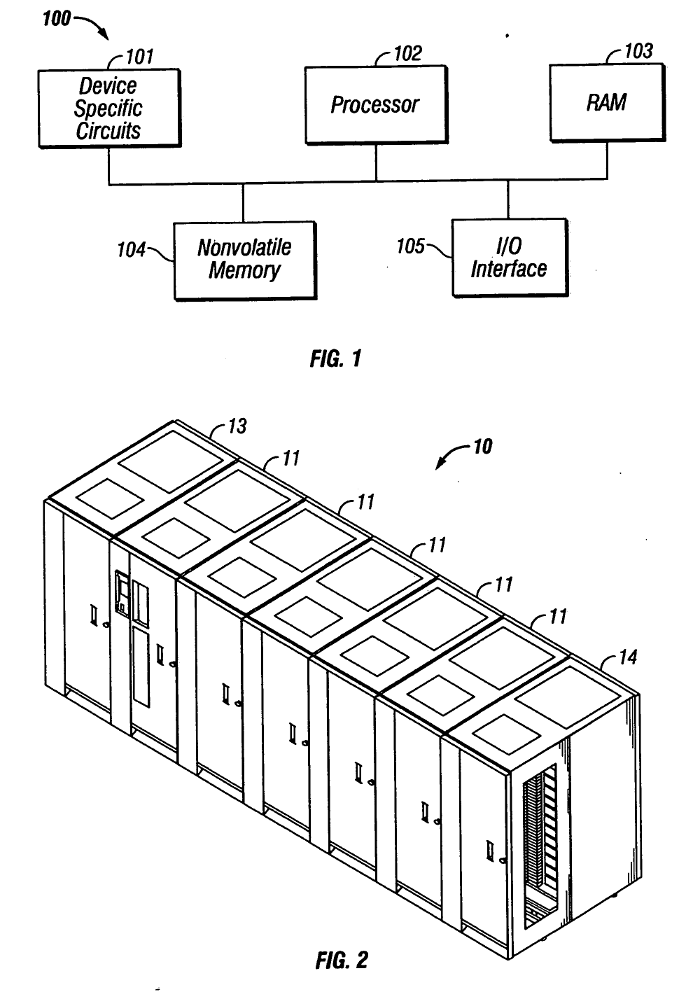

### DETAILED DESCRIPTION OF THE PREFERRED EMBODIMENTS

This invention is described in preferred embodiments in the following description. The preferred embodiments are described with reference to the Figures. While this invention is described in conjunction with the preferred embodiments, it will be appreciated by those skilled in the art that it is intended to cover alternatives, modifications, and equivalents as may be included within the spirit and scope of the invention as defined by the appended claims.

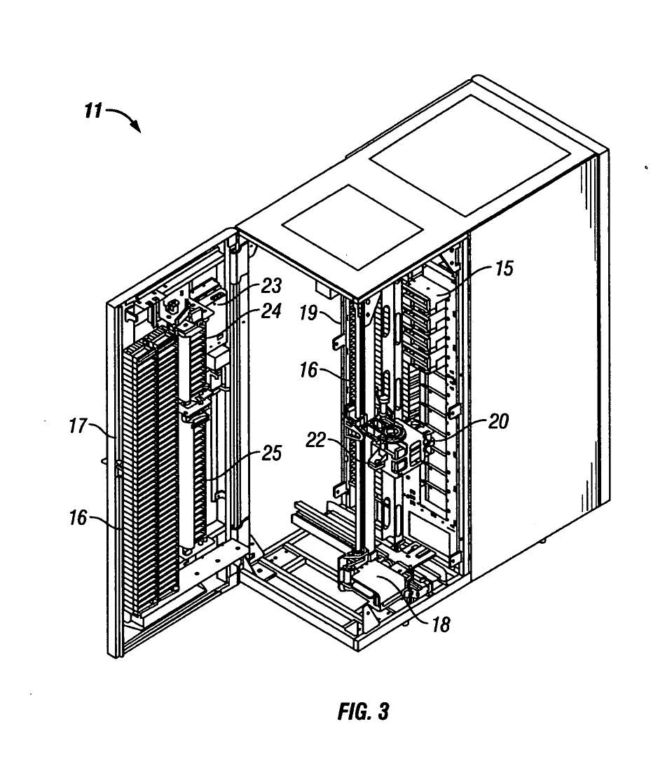

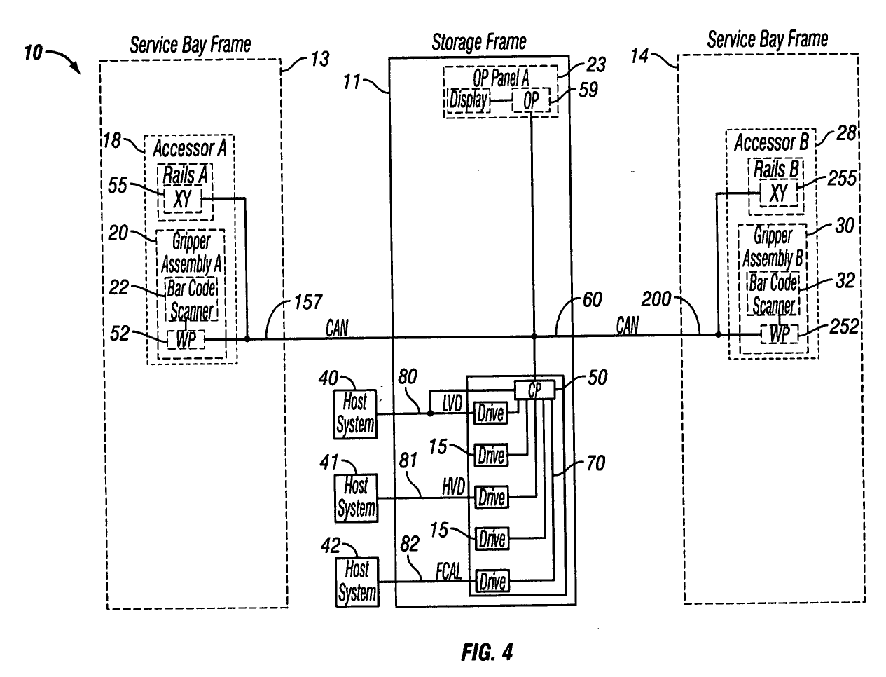

FIG. 4 illustrates an embodiment of an automated data storage library 10 of FIGS. 2 and 3, which employs a distributed system of modules with a plurality of processor nodes. An example of an automated data storage library which may implement the present invention is the IBM 3584 UltraScalable Tape Library. For a fuller understanding of a distributed control system incorporated in an automated data storage library, refer to U.S. Pat. No. 6,356,806 titled “Automated Data Storage Library Distributed Control System” which is incorporated herein for reference. While the library 10 has been described as a distributed control system, this invention applies equally to libraries that incorporate other control configurations such as one or more library controllers that are not distributed. The library of FIG. 4 comprises one or more storage frames 11, a left hand service bay 13 and a right hand service bay 14.

The left hand service bay 13 is shown with a first accessor 18. As discussed above, the first accessor 18 comprises a gripper assembly 20 and may include a reading system 22 to “read” identifying information about the data storage media. The right hand service bay 14 is shown with a second accessor 28. The second accessor 28 comprises a gripper assembly 30 and may include a reading system 32 to “read” identifying information about the data storage media. In the event of a failure or other unavailability of the first accessor 18, or its gripper 20, etc., the second accessor 28 may perform all of the functions of the first accessor 18. The two accessors 18, 28 may share one or more mechanical paths or they may comprise completely independent mechanical paths. In one example, the accessors 18, 28 may have a common horizontal rail with independent vertical rails. The first accessor 18 and the second accessor 28 are described as first and second for descriptive purposes only and this description is not meant to limit either accessor to an association with either the left hand service bay 13, or the right hand service bay 14. In addition, the present invention may operate with fewer or more than two accessors.

In the exemplary library, first accessor 18 and second accessor 28 moves their grippers in at least two directions, called the horizontal “X” direction and vertical “Y” direction, to retrieve and grip, or to deliver and release the data storage media at the storage shelves 16 and to load and unload the data storage media at the data storage drives 15.

The exemplary library 10 receives commands from one or more host systems 40, 41 or 42. The host systems, such as host servers, communicate with the library directly, e.g., on path 80, through one or more control ports (not shown), or through one or more data storage drives 15 on paths 81, 82, providing commands to access particular data storage media and move the media, for example, between the storage shelves 16 and the data storage drives 15. The commands are typically logical commands identifying the media and/or logical locations for accessing the media.

The exemplary library is controlled by a distributed control system receiving the logical commands from hosts, determining the required actions, and converting the actions to physical movements of first accessor 18 and/or second accessor 28.

In the exemplary library, the distributed control system comprises a plurality of processor nodes, each having one or more processors. In one example of a distributed control system, a communication processor node 50 may be located in a storage frame 11. The communication processor node provides a communication link for receiving the host commands, either directly or through the drives 15, via at least one external interface, e.g., coupled to line 80.

The communication processor node 50 may additionally provide a communication link 70 for communicating with the data storage drives 15. The communication processor node 50 may be located in the frame 11, close to the data storage drives 15. Additionally, in an example of a distributed processor system, one or more additional work processor nodes are provided, which may comprise, e.g., a work processor node 52 that may be located at first accessor 18 and that is coupled to the communication processor node 50 via a network 60, 157. A second work processor node 252 that may be located at second accessor 28 and that is coupled to the communication processor node 50 via a network 60, 200 may also be provided. Each work processor node may respond to received commands that are broadcast to the work processor nodes from any communication processor node, and the work processor node may also direct the operation of first accessor 18, providing move commands. An XY processor node 55 may be provided and may be located at an XY system of first accessor 18. The XY processor node 55 is coupled to the network 60, 157, and is responsive to the move commands, operating the XY system to position the gripper 20.

Also, an operator panel processor node 59 may be provided at the optional operator panel 23 for providing an interface for communicating between the operator panel and the communication processor node 50, the work processor node 52, and the XY processor node 55.

A network, for example comprising a common bus 60, is provided, coupling the various processor nodes. The network may comprise a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other networks, such as Ethernet, or a wireless network system, such as RF or infrared, may be employed in the library as is known to those of skill in the art. In addition, multiple independent networks may also be used to couple the various processor nodes.

The communication processor node 50 is coupled to each of the data storage drives 15 of a storage frame 11, via lines 70, communicating with the drives and with host systems 40, 41 and 42. Alternatively, the host systems may be directly coupled to the communication processor node 50, at input 80 for example, or to control port devices (not shown) which connect the library to the host system(s) with a library interface similar to the drive/library interface. As is known to those of skill in the art, various communication arrangements may be employed for communication with the host(s) and with the data storage drives. In the example of FIG. 4, host connections 80 and 81 are SCSI busses. Bus 82 comprises an example of a Fibre Channel-Arbitrated Loop which is a high speed serial data interface, allowing transmission over greater distances than the SCSI bus systems.

The data storage drives 15 may be in close proximity to the communication processor node 50, and may employ a short distance communication scheme, such as SCSI, or a serial connection, such as RS-422. The data storage drives 15 are thus individually coupled to the communication processor node 50 by means of lines 70. Alternatively, the data storage drives 15 may be coupled to the communication processor node 50 through one or more networks, such as a common bus network.

Additional storage frames 11 may be provided and each is coupled to the adjacent storage frame. Any of the storage frames 11 may comprise communication processor nodes 50, storage shelves 16, data storage drives 15, and networks 60.

Further, the automated data storage library 10 may additionally comprise a second accessor 28, for example, shown in a right hand service bay 14 of FIG. 4. The second accessor 28 may comprise a gripper 30 for accessing the data storage media, and an XY system 255 for moving the second accessor 28. The second accessor 28 may run on the same horizontal mechanical path as first accessor 18, or on an adjacent path. The exemplary control system additionally comprises an extension network 200 forming a network coupled to network 60 of the storage frame(s) 11 and to the network 157 of left hand service bay 13.

In FIG. 4 and the accompanying description, the first and second accessors are associated with the left hand service bay 13 and the right hand service bay 14 respectively. This is for illustrative purposes and there may not be an actual association. In addition, network 157 may not be associated with the left hand service bay 13 and network 200 may not be associated with the right hand service bay 14. Depending on the design of the library, it may not be necessary to have a left hand service bay 13 and/or a right hand service bay 14.

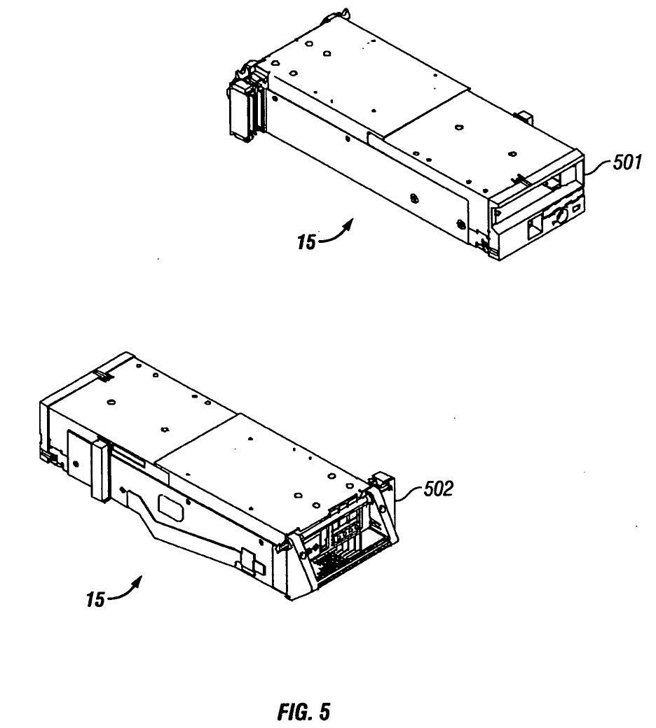

FIG. 5 shows a view of the front 501 and rear 502 of drive 15. In this example, drive 15 is a removable media LTO (Linear Tape Open) tape drive mounted in a drive canister. The drive canister may comprise a housing to hold drive 15, mounting means to attach drive 15 to the drive canister, electrical components, interface cables, interface connectors, etc. The data storage drive of this invention may comprise any removable media drive such as magnetic or optical tape drives, magnetic or optical disk drives, electronic media drives, or any other removable media drive as is known in the art.

In a first embodiment of the present invention a receiver is coupled to automated data storage library 10 to enable automated data storage library 10 to receive accurate time information from various sources. This is an advantage over prior art methods, for example battery powered real-time clocks as described above, for maintaining accurate time in an automated data storage library. Once coupled, a receiver may receive accurate time and/or date information from a GPS satellite, the Internet, an intranet or other network, a broadcast radio station or other source of radio signal, a broadcast TV station, a cellular telephone network, a paging system, a central service location during a “Call Home” service action, etc. By use of the present invention precise time information may be obtained by automated data storage library 10. Herein, time information may comprise time and/or date information.

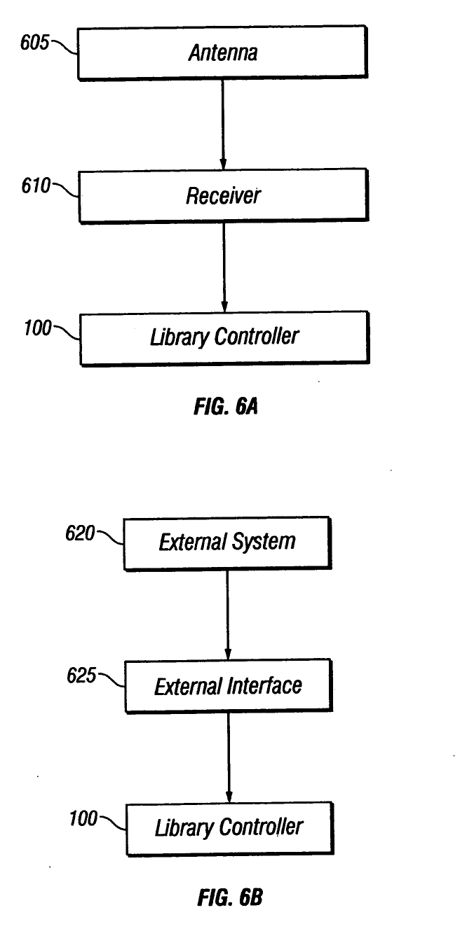

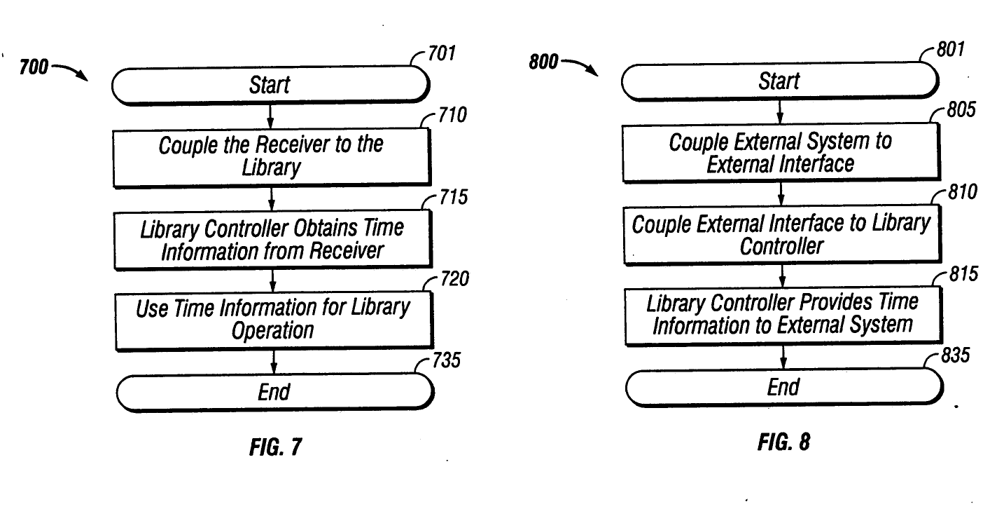

The method of the first embodiment can be better understood by referring to flowchart 700 shown in FIG. 7 and the block diagram shown in FIG. 6A. At step 710 receiver 610 is coupled to library controller 100. Library controller 100 may comprise a dedicated controller of a prior art library or it may comprise a processor node of a distributed control library, such as the library of FIG. 4. In the distributed control library of FIG. 4, library controller 100 may comprise any processor node such as work processor node 52, work processor node 252, communication processor node 50, etc. In addition, library controller 100 may comprise combinations of processor nodes, such as work processor node 52 and work processor node 252. Still further, library controller 100 may comprise all of the processor nodes. Herein, library controller may comprise a single controller or multiple controllers. Receiver 610 may comprise optional antenna 605. The library may comprise the automated data storage library 10 shown in FIG. 2 or other configurations or embodiments of data storage libraries. Receiver 610 may be coupled to library controller 100 at the time the library is manufactured, assembled, installed, modified or upgraded either at the factory, customer location or other location. Receiver 610 is coupled to library controller 100 through an interface. The interface may comprise a communication interface such as RS-232, a register interface such as address/data lines, an analog interface such as an audio or modem interface, a wireless interface such as Infrared or RF, or any other interface for conveying information as is known to those of skill in the art. In one implementation, receiver 610 comprises a television receiver coupled to at least one television antenna to receive a signal from the television antenna. Receiver 610 is capable of receiving all or part of a television broadcast signal. The television broadcast may comprise a commercial or private television broadcast. For example, in the United States, the Public Broadcasting System (PBS) television network and its affiliates provide time-of-day XDS (Extended Data Services) packets. In another implementation, receiver 610 comprises a radio receiver coupled to at least one radio antenna, to receive a signal from the radio antenna. Receiver 610 is capable of receiving part or all of a radio broadcast signal. The radio broadcast may comprise a commercial radio broadcast, may comprise a private radio broadcast, may comprise a broadcast for the purposes of time synchronization such as the NIST (National Institute of Standards and Technology) WWV, WWVB or WWVH radio broadcast stations, etc. The receiver may select a specific channel or frequency band that carries time information on a carrier signal of the television or radio broadcast signals. For example, RDS (Radio Data System) time code is sent using a 57 kHz subcarrier by some commercial FM (Frequency Modulated) radio stations in the United States. Alternatively, receiver 610 may be capable of receiving any radio signal that contains time and/or date information, as is known to those of skill in the art. In another implementation, receiver 610 comprises a cellular telephone receiver coupled to at least one cellular telephone antenna, to receive a signal from the cellular telephone antenna. Receiver 610 is capable of receiving part or all of a cellar telephone signal. The cellular telephone signal may comprise a commercial cellular telephone signal or a private cellular telephone signal. For example, a cellular telephone call may be established with a remote location that provides a time source over the cellular network. In another example, CDMA cellular telephone base stations may provide a time source using GPS receivers in the base stations. In another implementation, receiver 610 comprises a paging receiver capable of receiving part or all of a paging signal. The paging signal may comprise a commercial paging signal or a private paging signal. For example, the FLEX paging system provides time code referenced to GPS. In another implementation, receiver 610 comprises a GPS receiver coupled to at least one GPS antenna to receive a signal from the GPS antenna. Receiver 610 is capable of receiving part or all of a GPS broadcast. In any of the above implementations antenna 605 may comprise a low frequency, high frequency or very high frequency RF antenna such as a dipole or vertical beam. Alternatively, antenna 605 may comprise a microwave antenna such as a wave guide horn, parabolic dish, patch, quadrifilar, etc. In addition, antenna 605 may comprise an optical antenna such as an optical detector. Still further, antenna 605 may comprise any device for collecting wireless energy for the purpose of conveying information, as is known to those of skill in the art. Antenna 605 may be attached to the library at the time the library is manufactured, assembled, installed, modified or upgraded either at the factory, customer location or other location. In some embodiments, antenna 605 may not be present, as will be discussed. In other embodiments, antenna 605 may be integrated with receiver 610 or it may be attached anywhere on, or in, the library. Alternatively, antenna 605 may be separate from and coupled to the library. For example, better reception may be obtained by locating antenna 605 at some other location other than on, or in, the library. In any of the above embodiments receiver 610 receives a signal from an antenna or other means. At step 715, receiver 610 provides information derived from the signal to library controller 100. Library controller 100 receives information derived from the signal and obtains time information from the information. The information and time information may be different. For example, the information may be in a different format or time frame than is required for the time information. The time information may comprise a local time, national standard time, GPS time, elapsed time since a certain time and date, etc. In addition, the time information may comprise any unit of measure for time and date information. At step 720, library controller 100 uses the time information from receiver 610 for operation of automated data storage library 10.

In a second embodiment, the automated data storage library receives time information from a device on a network. In this embodiment, antenna 605 may not be present and receiver 610 comprises a network interface to provide a connection to at least one network device. The network interface may comprise telephone lines, a wireless link such as RF or Infrared, a communication interface such as Ethernet or Token Ring, a data interface such as Fibre Channel or SCSI, a dedicated interface such as RS-232, a serial interface such as CAN or USB, or any other interface for connecting two or more devices for the purpose of exchanging information, as is known to those of skill in the art. Receiver 610 is coupled to at least one network device to receive a signal from the network device. Receiver 610 may be coupled to the network device using a dedicated connection, a LAN (Local Area Network), a WAN (Wide Area Network), a SAN (Storage Area Network), an intranet, the Internet, or any other connection that may be used to couple two or more devices, as is known to those of skill in the art. The network device may comprise a computer or workstation, a computer peripheral, a network appliance, or any other computing device, as is known to those of skill in the art. As described above receiver 610 provides information derived from the signal to library controller 100. Library controller 100 receives information derived from the signal from receiver 610, and obtains time information from the information. The time information may be obtained using an Internet protocol such as SNTP (Simple Network Time Protocol), HTTP (Hyper Text Transfer Protocol), UDP (User Datagram Protocol), or any other network protocol known to those of skill in the art. Alternatively, the time information may be obtained using any protocol, including a proprietary protocol.

In one example of the second embodiment, the automated data storage library receives time information from another computer or network appliance that provides a time service using the SNTP (Simple Network Time Protocol). In another example, a remote computer provides time information by simply passing the date and time in an ASCII or binary form.

In yet another example, a remote computer provides time information as a secondary function. In this example receiver 610 comprises a remote computer interface to provide the connection to at least one remote computer. Receiver 610 is coupled to at least one remote computer to receive a signal from the remote computer. Receiver 610 may be coupled to at least one remote computer using any interface or connection described above. The remote computer may comprise a host computer, personal computer, workstation, etc. As described above receiver 610 provides information derived from the signal to library controller 100. Library controller 100 receives information derived from the signal from receiver 610, and obtains time information from the received information. For example, a feature often referred to as “Call-Home” is used to expedite service and repair of an automated data storage library. Call-Home is a feature where the library will call a service or repair center when it detects an operational error. Another feature, called “Heartbeat Call-Home” involves a periodic call to a service or repair center as a watchdog function. In one example of a call-home facility, the library comprises a modem. The modem is connected to a telephone line and the library uses the modem to dial the telephone number of a public or private network. After authenticating the library access to the network, a network connection to a remote computer is established to transfer information to/from the library. For example, the library may transfer error logs to the remote computer. Automated data storage library 10 may obtain time information from a remote computer during the call-home operation. This may occur periodically, or automated data storage library 10 may initiate a call-home when it needs to update time information. For example, upon power up, automated data storage library 10 may initiate a call-home to update time information.

The time information obtained for any embodiment or implementation described herein may be used for library operation. The library may use this time information to schedule events, such as drive cleaning operations. The library may also use this information for time and/or date stamps in error logs, etc. As described above, automated data storage libraries typically includes a Real-Time Clock (RTC) to provide time information for library operations. The RTC may be completely eliminated by using the time information obtained by use of the present invention. With the elimination of the RTC, the need for batteries or other power sources to supply energy to the RTC is also eliminated. The chance of operator error is also eliminated as the library time will be automatically maintained.

The time information obtained through the present invention may also be used in conjunction with a real-time clock (RTC). In one implementation, the RTC provides a backup to the received time such that a failure to properly receive time information will result in the RTC providing the time information. In another implementation the received time provides a backup to the RTC such that a failure of the RTC or its battery results in the receiver providing the time information. In another implementation, the received time of the present invention may be used to set the RTC at an interval. In one variation of this implementation, the interval is the time between power cycles or resets. In this variation, the received time may be used to set the RTC time after a power on or reset. The library controller 100 may detect that it has cycled through a reset by reading a processor register, hardware register, power supply status, or any other method of determining that a device has cycled through a reset or power cycle, as is known to those of skill in the art. Alternatively, the library controller may detect that it has gone through a reset through some other means, such as an RTC time that appears to be invalid. The RTC time may appear to be invalid if the date or time appears as an unrealistic value. For example, the firmware that implements this invention may have a compile date of 2004. The date from the RTC after a power loss may appear as 1980. This would result in a possible invalid RTC time because the date should be sometime on or after 2004. In another variation of this implementation, the interval is the time between a loss of RTC backup power. In this variation, the received time may be used to set the RTC time after it has lost its backup power source. The backup power source may comprise a capacitor, battery, or any other power source independent from the library controller 100 power source. The library controller may detect that the RTC has lost its backup power source by reading status from the RTC, by monitoring the backup power source voltage, etc. Alternatively, the library controller may detect that the RTC has lost its backup power source by some other means, such as an RTC time that appears to be invalid as described above. In another variation of this implementation, the interval is some periodic interval of time. In this variation, the received time would be used to periodically synchronize the RTC. This would compensate for any potential time drift that is common among real-time clocks. For example, the library controller may use the received time to set the RTC once every day. There may be rules that will only allow the RTC time to be corrected or set if the RTC time differs from the received time by a predetermined maximum amount of time. This would prevent incorrectly setting the RTC time when the received time is incorrect. The received time could also be used to compensate for daylight savings time, leap year, or other time differences that are not always compensated for by real-time clocks. The periodic interval may range from seconds to many months or more. Any of the implementations that use the received time to assist with proper operation of an RTC have the advantage of a backup to time and/or date information while eliminating the need for operator intervention for failures and time changes, such as daylight savings time, loss of backup power, etc. In addition, potential operator errors that may occur from incorrectly setting the time and/or date of the RTC are eliminated.

In a third embodiment, automated data storage library 10 obtains and also provides time information to/from various external systems using an external interface. In this embodiment, automated data storage library 10 further comprises an external interface for interfacing to one or more external systems. Automated data storage library 10 may also provide time information that it has obtained through receiver 610 to external systems. The external interface may comprise telephone lines, a wireless link such as RF or Infrared, a data link such as SCSI or Fibre Channel, a communication link such as Ethernet, a dedicated link such as RS-232, or any other interface as is known to those of skill in the art. In one implementation of this embodiment, automated data storage library 10 provides time information to an external system that comprises one or more storage subsystems. The storage subsystems may comprise RAID (Redundant Array of Independent Drives), other automated data storage libraries, virtual tape systems, or any other storage subsystem as is known to those of skill in the art. In another implementation of this embodiment, automated data storage library 10 provides time information to an attached host computer. For example, automated data storage library 10 and any associated host computers may use the time information to synchronize each other to the same time. In another implementation of this embodiment, automated data storage library 10 provides time information to one or more devices on a network. The network device may comprise a computer, a computer peripheral, a network appliance, or any other network device as is known to those of skill in the art. The method of the third embodiment can be better understood by referring to flowchart 800 shown in FIG. 8 and the block diagram shown in FIG. 6B. At step 805, an external system 620 is coupled to an external interface 625. The external system 620 may comprise a storage subsystem, host computer, or customer network. At step 810, library controller 100 is coupled to the external interface 625. Library controller 100 may be coupled to external interface 625 at the time the library is manufactured, assembled, installed, modified or upgraded either at the factory, customer location or other location. At step 815, library controller 100 provides time information to the external system 620 using the external interface 625. The time information may be provided using an Internet protocol such as SNTP (Simple Network Time Protocol), HTTP (Hyper Text Transfer Protocol), UDP (User Datagram Protocol), or any other network protocol known to those of skill in the art. Alternatively, the time information may be provided using any protocol, including a proprietary protocol. The time information may comprise local time, national standard time, GPS time, elapsed time since a certain time and date, etc. In addition, the time information may comprise any unit of measure for time and date information. The received time and the provided time may differ. For example, the received time may be in a different format or time frame than is required for the provided time. In this implementation, time delays associated with receiving, processing and transmitting the time information may be compensated for in automated data storage library 10 by further processing of the time information.

The invention disclosed herein may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

While the preferred embodiments of the present invention have been illustrated in detail, the skilled artisan will appreciate that modifications and adaptations to those embodiments may be made without departing from the scope of the present invention as set forth in the following claims.

1 A method for obtaining time information in an automated data storage library, said automated data storage library having a library controller for operating said automated data storage library, where said method comprises the steps of:
a.) receiving a first signal using a first receiver;
b.) providing information derived from said first signal to said library controller; and
c.) obtaining time information from said information;
d.) said library controller using said time information for library operations.

2 The method of claim 1, wherein said receiver comprises at least one GPS receiver.

3 The method of claim 1, wherein said receiver comprises at least one radio receiver.

4 The method of claim 1, wherein said receiver comprises at least one television receiver.

5 The method of claim 1, wherein said receiver comprises at least one cellular telephone receiver.

6 The method of claim 1, wherein said receiver comprises a network interface for interfacing to one or more devices, and wherein said receiving step further comprises said receiver receiving said first signal from said one or more devices using said network interface.

7 The method of claim 1, wherein said receiver comprises a remote computer interface for interfacing to at least one remote computer and wherein said receiving step further comprises said receiver receiving said first signal from said at least one remote computer.

8 The method of claim 1, wherein said automated data storage library further comprises an external interface for interfacing to at least one external system, comprising the additional step of said automated data storage library providing said time information to said at least one external system.

9 The method of claim 1, wherein said automated data storage library further comprises an internal real-time clock, where said method comprises the additional steps of synchronizing said real-time clock with said time information at an interval.

10 A system for obtaining time information, comprising:
a) an automated data storage library;
b) a library controller for operating said automated data storage library; and
c) a receiver coupled to said library controller, wherein said library controller obtains time information from said receiver and uses said time information for library operations.

11 The system of claim 10, wherein said receiver comprises at least one GPS receiver coupled to at least one GPS antenna.

12 The system of claim 10, wherein said receiver comprises at least one radio receiver coupled to at least one radio antenna.

13 The system of claim 10, wherein said receiver comprises at least one television receiver coupled to at least one television antenna.

14 The system of claim 10, wherein said receiver comprises at least one cellular telephone receiver coupled to at least one cellular telephone antenna.

15 The system of claim 10, wherein said receiver comprises a network interface for interfacing to one or more devices coupled to said network interface.

16 The system of claim 10, further comprising at least one remote computer and wherein said receiver comprises a remote computer interface for interfacing to said at least one remote computer.

17 The system of claim 10, further comprising:
a) at least one external system; and
b) an external interface, for interfacing to said at least one external system and coupled to said library controller, wherein said library controller provides said time information to said at least one external system.

18 The system of claim 10, further comprising an internal real-time clock, wherein said internal real-time clock is synchronized with said time information at an interval.

19 An article of manufacture comprising a data storage medium tangibly embodying a program of machine-readable instructions executable by a digital processing apparatus to perform method steps for obtaining time information in an automated data storage library, said automated data storage library having a library controller for operating said automated data storage library, a first receiver for receiving a first signal and where said method comprises the steps of:
a.) providing information derived from said first signal to said library controller;
b.) obtaining time information from said information; and
c.) said library controller using said time information for library operations.

20 The article of manufacture of claim 19, wherein said automated data storage library further comprises an external interface for interfacing to at least one external system and wherein said method comprises the additional step of said automated data storage library providing said time information to said at least one external system.
